(19) United States
(12) Patent Application Publication
(10) Pub. No.: US 2025/0033240 A1
(43) Pub. Date: Jan. 30, 2025

(54) BALSA-LIKE WOOD ALTERNATIVE PRODUCTS AND METHODS FOR PREPARING SAME

(71) Applicant: INCA RENEWABLE TECHNOLOGIES INC., Kelowna (CA)

(72) Inventors: Garry BALTHES, Kelowna (CA); Karl NICHOLAS, Kelowna (CA)

(21) Appl. No.: 18/717,198

(22) PCT Filed: Dec. 7, 2022
(86) PCT No.: PCT/CA2022/000059

§ 371 Date: Jun. 6, 2024

Related U.S. Application Data
(60) Provisional application No. 63/286,942, filed on Dec. 7, 2021.

(51) Int. Cl. B27N 3/04; B27N 3/00

(52) U.S. Cl. CPC B27N 3/04; B27N 3/002

(57) ABSTRACT

Provided is a balsa-like wood alternative product comprising a plant hurd material, low-density spheres, and a binding agent. Also provided are intermediate products to the balsa-like wood alternative product, and methods for making both the balsa-like wood alternative product and the intermediates. Depending on proportions of hurd material, low-density spheres, and binder, various intermediate and final products are formed, including, but not limited to, structural and finishing building elements, a wind-turbine blade core, medium-density fiberboard, automotive interior components, bowls, trays, plates and pans; fuel pellets, personal and environmental absorbent articles including animal bedding and litter, and sanitary articles.

### CROSS-REFERENCE TO RELATED APPLICATIONS

This application claims priority to and benefit from U.S. Patent Application Ser. No. 63/286,942 filed on Dec. 7, 2021, which is hereby incorporated by reference in its entirety.

### TECHNICAL FIELD

The present disclosure generally relates to a balsa-like wood alternative product and to methods for making the same, and in particular to balsa-like wood products comprising a plant hurd material, low-density spheres, and a binding agent.

### BACKGROUND

Ochroma pyramidale, commonly known as the balsa tree, is a large, fast-growing tree native from southern Mexico to southern Brazil (but now found in many other countries). Although it is classified as a hardwood, balsa wood is very soft and has a density lower than cork. In fact, it is the softest commercial hardwood. It is widely used because of its fast growth rate (27 m/10-15 years) and its light weight.

Balsa lumber is very soft and light. It has a coarse, open grain and a density typically in the range between about 5 lbs/ft³ to about 20 lbs/ft³, with the density being influenced by both species and location. By the Janka hardness test, balsa has a measurement of 22 to 167 lbf. Balsa wood has large cells for holding water, making the wood of a living tree not much lighter than water and barely able to float. However, when dried these empty cells give the dry balsa a large strength-to-weight ratio, retaining their strong structure of cellulose and lignin.

Because of its low density and high strength, balsa wood has a number of applications for light, stiff structures. For example, balsa wood is often used as a core material in composites (e.g. in the blades of wind turbines), as well as in laminates (e.g. surfboards, decks, topsides of boats, etc.), and sandwiched within sheets of carbon-fiber-reinforced plastic.

One of the most sought-after markets for balsa is in the wind turbine blade market. Balsa is used as a bridge filler to reduce blade weight and increase blade stiffness. This is accomplished by placing shaped balsa in the core of the blade and then surrounding it in styrene or epoxy resonated glass fiber mats. This ends in the blade skins being put into tension loading on one surface and compression loading on the opposite surface supported by rigid balsa wood as the bridge mechanism to keep the two outer layers from collapsing to each other. Balsa wood for turbine blade manufacturing must typically have a preferred density of about 10 lbs/ft³.

Although balsa wood has many great qualities, there simply is not enough supply to meet growing market demands. Historically, Ecuador has supplied 95% or more of commercial balsa. However, in recent years, about 60% of the balsa has been plantation grown. Since standing, old growth balsa is largely depleted, balsa plantations were developed to ensure a consistent supply of balsa fiber to support blade manufacturing. However, due to the length of time needed to produce balsa logs large enough to extract long cut boards, the industry adopted crosscut grain balsa as a suitable product for the purpose of forming stress skin panels. For crosscut grain balsa, the loading on the balsa fiber is against the growing direction of the fiber, rather than in line with fiber growth direction.

This development in balsa manufacturing has added considerable cost to manufacturing balsa dimensional sheets, since each crosscut section of tree stalk has to be cut in a rectangular shape to allow block to block gluing to form desired planks. In addition, balsa planks formed in this way have very little flexural modulus strength due to loading being applied in the fiber direction, rather than across the fiber direction as is typical for normal wood. Where balsa gains its strength is the use of adhesives that weight out balsa providing more fiber-to-fiber bonding as well as being layered with glass fiber roving.

A need thus exists for products that can replace naturally grown balsa wood.

### SUMMARY

The present disclosure provides a balsa-like wood alternative product, intermediates to such products, and to methods for making both of the same.

The present disclosure recognizes that there are problems relating to balsa wood supply and existing processes for using balsa wood in desired applications.

An advantage of the present disclosure is the provision of balsa-like wood alternative products and methods for use as suitable and sustainable replacement to natural balsa wood.

In an embodiment, the present disclosure relates to a balsa-like wood alternative product comprising a plant hurd material, low-density spheres, and a binding agent.

In an embodiment, the balsa-like wood alternative product of the present disclosure comprises between about 20% and about 75% by weight of the plant hurd material; between about 1% and about 25% by weight of the low-density spheres; and between about 10% and about 75% by weight binding agent.

In an embodiment, the balsa-like wood alternative product of the present disclosure comprises between about 40% and about 60% by weight plant hurd material; between about 2% and about 15% by weight low-density spheres; and between about 40% and about 60% by weight binding agent.

In an embodiment of the balsa-like wood alternative product herein, the plant hurd material is from hemp, jute, kenaf, ramie, flax, or any combination thereof. In a particular embodiment, the plant hurd material is from hemp. In an embodiment, the plant hurd material used in the balsa-like wood alternative products herein has fibers having an average particle size of about 0.125 inches by about 0.25 inches.

In an embodiment, the balsa-like wood alternative product of the present disclosure comprises between about 43% and about 58% by weight of the plant hurd material, and more particularly between about 44% and about 55% by weight of the plant hurd material.

In an embodiment, the binding agent of the balsa-like wood alternative products of the present disclosure comprises an acrylic resin, an acrylic emulsion, a polymer dispersion, a styrene resin, a styrene-butadiene dispersion, an epoxy resin, an epoxy powder, a polyester, a phenolic resin, a latex polymer, or any combination thereof. In an embodiment, the binding agent comprises at least one dry epoxy powder and at least one latex polymer. In an embodiment, the at least one latex polymer is a reactive thermoset latex, a thermoplastic latex, or a combination thereof. In an embodiment, the at least one latex polymer is a water-based latex thermoplastic acrylic. In an embodiment, the latex polymer comprises one or more functional groups selected from the group consisting of an alcohol, a carboxylic acid, or an amine.

In an embodiment, the balsa-like wood alternative product of the present disclosure comprises between about 42% and about 52% by weight of the binding agent, and more particularly between about 45% and about 51% by weight binding agent.

In an embodiment of the balsa-like wood alternative product herein, the low-density spheres are polymeric microspheres. In an embodiment, the low-density spheres comprise polymeric microspheres, glass microspheres, ceramic microspheres, or any combination thereof.

In an embodiment, the balsa-like wood alternative product of the present disclosure comprises between about 4% and about 10% by weight low-density spheres.

In an embodiment, the balsa-like wood alternative product of the present disclosure comprises the low-density spheres at about 20% by weight of cellulose weight in the product.

In an embodiment, the balsa-like wood alternative product of the present disclosure further comprises a flame retardant, an adhesive, a coloring agent, a fragrance agent, a hydrophobic ingredient, an enzyme, a wetting agent, an anti-static agent, a bactericide, a fungicide, a filler, a UV stabilizer, a rust inhibitor, or any combination thereof.

In an embodiment, the balsa-like wood alternative product of the present disclosure is extruded to a pre-determined shape and size.

In an embodiment, the balsa-like wood alternative product of the present disclosure has a density of between about 8 lbs/ft³ and 12 lbs/ft³.

In an embodiment, the balsa-like wood alternative product of the present disclosure comprises: about 46% by weight of the plant hurd material; about 9% by weight of the low-density spheres; and about 45% by weight of the binding agent. In an embodiment, the balsa-like wood alternative product comprises about 15% by weight epoxy powder and about 30% by weight acrylic resin as the binding agent.

In an embodiment, the balsa-like wood alternative product of the present disclosure comprises about 44% by weight plant hurd material; about 4% by weight low-density spheres; and about 51% by weight binding agent. In an embodiment, the balsa-like wood alternative product comprises about 12% by weight epoxy powder; about 23% by weight acrylic resin; and about 16% by weight styrene-butadiene dispersion as the binding agent.

In an embodiment, the balsa-like wood alternative product of the present disclosure comprises about 49% by weight plant hurd material; about 5% by weight low-density spheres; and about 46% by weight binding agent. In an embodiment, the balsa-like wood alternative product comprises about 15% by weight epoxy powder and about 31% by weight acrylic resin as the binding agent.

In an embodiment, the present disclosure relates to a balsa-like intermediate product comprising a plant hurd material, low-density spheres, a binding agent, and at least 5% by weight of an aqueous medium. In an embodiment of the balsa-like intermediate product herein, the aqueous medium is water.

In an embodiment, the balsa-like intermediate product of the present disclosure comprises between about 20% and about 75% by weight of the plant hurd material; between about 1% and about 25% by weight of the low-density spheres; between about 10% and about 75% by weight binding agent; and between about 5% and about 20% of the aqueous medium.

In an embodiment, the balsa-like intermediate product of the present disclosure comprises between about 30% and about 60% by weight of the plant hurd material; between about 2% and about 15% by weight of the low-density spheres; between about 30% and about 50% by weight binding agent; and between about 8% and about 18% of the aqueous medium.

In an embodiment, the balsa-like intermediate product of the present disclosure comprises between about 35% and about 45% by weight of the plant hurd material; between about 5% and about 10% by weight of the low-density spheres; between about 35% and about 45% by weight binding agent; and between about 10% and about 15% of the aqueous medium.

In an embodiment of the balsa-like intermediate product herein, the plant hurd material is from hemp, the low-density spheres are polymeric microspheres, and the binding agent comprises at least one dry epoxy powder and at least one latex polymer.

In an embodiment, the balsa-like intermediate product of the present disclosure comprises the aqueous medium at about 40% by weight of cellulose weight in the product.

In an embodiment, the present disclosure relates to a method for preparing a balsa-like wood alternative product, the method comprising: providing a plant hurd material comprising at least 75% hurd by weight; combining the plant hurd material with an aqueous medium to provide a hydrated hurd mixture; combining, in any order, the hydrated hurd mixture with low-density spheres and one or more binding agents to provide a balsa-like intermediate product; drying the balsa-like intermediate product to provide the balsa-like wood alternative product. In an embodiment, the aqueous medium is water.

In an embodiment of the methods disclosed herein, the step of combining the plant hurd material with the aqueous medium comprises mixing the aqueous medium into the plant hurd material to hydrate cellulose within the plant hurd material.

In an embodiment of the methods disclosed herein, the step of combining the hydrated hurd mixture with the low-density spheres and the one or more binding agents comprises: mixing the hydrated hurd mixture with the low-density spheres to provide a low-density hurd mixture; and mixing the low-density hurd mixture with the one or more binding agents to provide the balsa-like intermediate product. In an embodiment, the plant hurd material comprises at least 95% hurd by weight, and more particularly at least 99% hurd by weight.

In an embodiment of the methods disclosed herein, the step of providing the plant hurd material comprises decorticating a plant material to separate a hurd component from the plant material. In an embodiment, hurd fibers of the plant hurd material have an average particle size of about 0.125 inches by about 0.25 inches.

In an embodiment of the methods disclosed herein, the step of combining the plant hurd material with the aqueous medium comprises mixing the aqueous medium into the plant hurd material to hydrate cellulose within the plant hurd material.

In an embodiment of the methods disclosed herein, the step of combining the hydrated hurd mixture with the low-density spheres and the one or more binding agents comprises mixing the hydrated hurd mixture with the low-density spheres to provide a low-density hurd mixture; and mixing the low-density hurd mixture with the one or more binding agents to provide the balsa-like intermediate product.

In an embodiment of the methods disclosed herein, the step of drying the balsa-like intermediate product comprises heating. In an embodiment, the combining steps comprise a high shear mixing. In an embodiment, the combining steps are performed until substantially homogenous mixtures are provided.

In an embodiment of the methods disclosed herein, the step of combining the plant hurd material with the aqueous medium comprises agitating the plant hurd material; and spraying the aqueous medium as a fine mist onto the plant hurd material during the agitation.

In an embodiment of the methods disclosed herein, the aqueous medium is combined with the plant hurd material at an amount of between about 30% and about 50% by weight of the plant hurd material.

In an embodiment of the methods disclosed herein, the aqueous medium is combined at an amount of about 40% by weight of cellulose weight in the plant hurd material.

In an embodiment of the methods disclosed herein, the low-density spheres are combined at an amount of about 20% by weight of cellulose weight in the plant hurd material.

In an embodiment of the methods disclosed herein, after drying, the balsa-like wood alternative product comprises: between about 20% and about 75% by weight of the plant hurd material; between about 1% and about 25% by weight of the low-density spheres; and between about 10% and about 75% by weight binding agent.

In an embodiment of the methods disclosed herein, after drying, the balsa-like wood alternative product comprises between about 40% and about 60% by weight plant hurd material; between about 2% and about 15% by weight low-density spheres; and between about 40% and about 60% by weight binding agent

In an embodiment of the methods disclosed herein, the step of drying the balsa-like intermediate product comprises pressing the balsa-like intermediate product into a balsa-like cake; heating the balsa-like cake to one or more temperatures between about 120° C. and about 180° to dry the balsa-like cake; curing the dried balsa-like cake at a temperature between about 160° C. and 180° C.; and cooling the cured balsa-like cake to between about 15° C. and about 30° C. to provide the balsa-like wood alternative product. In an embodiment, the heating and curing steps are at a temperature of at most 165° C.

In an embodiment of the methods disclosed herein, the plant hurd material used as a starting material in the methods is a high-absorbency hurd material as described herein.

In an embodiment, the present disclosure relates to a balsa-like wood alternative product prepared by the methods as disclosed herein.

In an embodiment, the present disclosure relates to use of the balsa-like wood alternative product of the present disclosure as an alternative to natural balsa wood.

In an embodiment, the present disclosure relates to use of the balsa-like wood alternative product of the present disclosure as a core material in composites, laminates, or between sheets of carbon-fiber-reinforced plastic.

In an embodiment, the present disclosure relates to use of the balsa-like wood alternative product of the present disclosure as a wind turbine blade, a surfboard, a deck board, a component of a boat, or a component of an automobile. In an embodiment, the component of the boat may be a topside component, such as for example a wall or a floor of the boat. In an embodiment, the component of the automobile may be an interior component, such as for example a trim piece (e.g. dashboard, door, etc.) or a headliner.

Other aspects and features of the methods and balsa-like wood alternative products of the present disclosure will become apparent to those ordinarily skilled in the art upon review of the following description of specific embodiments.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary suitable methods and materials are described below.

The present disclosure provides a balsa-like wood alternative product comprised of plant hurd material (also known as core or shives), low-density spheres, and a binding agent. The hurd may, for example, be from the stem of Industrial Hemp (Cannabis Sativa). The products and methods of the present disclosure advantageously provide a balsa-like wood alternative product that has similar properties to natural balsa wood.

Advantageously, the balsa-like wood alternative products herein expand on the natural low density properties of hurd. More particularly, the balsa-like wood alternative product of the present disclosure exhibits relatively high compression strength while retaining its low-density properties. The high compression strength is relevant, for example, for use of the balsa-like wood alternative products herein as a foundation in sandwich panel construction (layering fiberglass, epoxy, and phenolic or styrene resins) to provide sufficient girth and increase flexural strength. These properties allow for use of the balsa-like wood alternative product as a reliable substitute in wind turbine blades, and boat and automotive applications.

Another advantage of the present disclosure is the ability to formulate, for example by the methods herein, a balsa-like wood alternative product to specific densities with specific physical properties. Natural balsa wood properties vary from tree to tree as well as from season to season. The balsa-like wood alternative product disclosed herein offers a more consistent and reliable material of construction than natural balsa wood. Indeed, by the methods herein, variations of the balsa-like wood alternative product are possible in order to balance density with desired physical properties.

Moreover, balsa-like wood alternative products produced from hurd materials (e.g. hemp) allow for use of a sustainable and renewable natural resource to supplement the limited supply of natural balsa wood. The unique properties of natural balsa wood has led to a growing market demand. Available plantation grown natural balsa wood is supplemented by illegally harvested natural balsa wood, creating further environmental damage. The ability to provide a balsa-like wood alternative product advantageously will lower our global CO₂ footprint and preserve wild growths of natural balsa wood.

It is further demonstrated herein that a high-absorbency hurd material composed of hurd can be provided. This high-absorbency hurd material may be used in the production of the balsa-like wood alternative products herein.

### Methods for Preparing High-Absorbency Hurd Material

In some embodiments, the present disclosure relates to a method for preparing a high-absorbency hurd material, the method comprising: combining a plant hurd material with an aqueous medium to form a mixture, the aqueous medium heated before, during or after admixture with the plant hurd material; mixing to separate or disperse fibers of the plant hurd material within the aqueous medium; removing at least a portion of the aqueous medium to form a hurd cake; and drying the hurd cake to prepare a high-absorbency hurd material.

As used herein, the term “plant hurd material” is intended to refer to the inner components, or core, of a plant. Plant hurd material, sometimes called shives or boon, may be a by-product of fiber production and may comprise wooden refuse. The plant hurd material herein may be from any plant having a core or a hurd. In some embodiments, the plant hurd material is a hemp hurd material, a jute hurd material, a kenaf hurd material, a ramie hurd material, a flax hurd material, or any combination thereof. In a particular embodiment, the plant hurd material is a hemp hurd material. As used herein, the term “hemp” is intended to refer to Cannabis sativa and includes industrial hemp. In an embodiment, the plant hurd material is a constituent of hemp straw.

As used herein, the term “aqueous medium” is intended to refer to a liquid in which the solvent is water or is substantially comprised of water. For example, in an embodiment, an aqueous medium is one in which other components in the medium are dissolved in water. In some embodiment, the aqueous medium may be water, an electrolyte solution, a nonelectrolyte solution, a bodily fluid (e.g. urine), or any other liquid having water as a solvent. In some embodiments, the aqueous medium is water. In an embodiment, the aqueous medium used in the preparing the high-absorbency hurd material is water, and the resulting high-absorbency hurd material has improved absorbency to the same (i.e. water) or a different aqueous medium (e.g. urine).

The plant hurd material and the aqueous medium may be combined in any suitable vessel and by any suitable means to bring the components together. In an embodiment, the combining is by adding the aqueous medium to the plant hurd material. In an embodiment, the combining is by adding the plant hurd material to the aqueous medium. The aqueous medium may be heated before, during or after admixture with the plant hurd material. In some embodiments, the aqueous medium is heated before and after admixture with the plant hurd material. In some embodiments, the aqueous medium is heated only before or only after admixture with the plant hurd material. In some embodiments, the aqueous medium may heated to or near to its boiling point before admixture with the plant hurd material. In an embodiment, the aqueous medium is heated to its boiling point before admixture with the plant hurd material. Heating may be maintain after admixture.

Non-limiting examples of containers that may be suitable for the combining step of the methods disclosed herein include a container, a bowl, a mixer, a blender, a pot, or a jar, each of any suitable size. The combining may be done in the same container as the mixing, or not.

In some embodiments, the combining step may comprise allowing the components to stand together for a period of time prior to the mixing step. In some embodiments, the components may be allowed to stand together for a period of between about 1 minute and about 20 minutes. In some embodiments, the components may be allowed to stand together for a period of time between about 5 minutes and about 10 minutes.

In some embodiments, during the combining step, the plant hurd material is heated or cooked in the aqueous medium. The heating may be by any suitable means, including conduction heating, convection heating, or electromagnetic (radiation) heating. The heating or cooking may be done in the same vessel as the combining, the mixing, the combining and the mixing, or neither the combining nor the mixing. In an embodiment, at least a portion of the combining step is under pressure.

Without being bound by any particular theory, the step of combining may result in softening of the plant hurd material.

The step of mixing may be by any suitable means to separate or disperse fibers of the plant hurd material within the aqueous medium. By “separate” it is intended to mean to disassociate the individual fibers from each other, at least partially or in whole. By “disperse” it is intended to mean to spread the fibers throughout the mixture, optionally in a uniform manner. In some embodiments, the mixing is by high shear mixing (e.g. blending), shaking, or stirring. In a particular embodiment, the mixing step comprises high shear mixing.

In some embodiments, the mixing is by a continuous flow pressure cooker. In some embodiments, the mixing may use an industrial grade mixer, or a continuous flow mixer. In a particular embodiment, the mixing is by a continuous flow mixer configured to receive other components such as, but not limited to, additives, coloring, fragrance, hydrophobic ingredients, binding agents, flame retardants, enzymes, wetting agents, anti-static agents (anti-stats), bactericides, fungicides, fillers, UV stabilizers, rust inhibitors, or any combination thereof.

In some embodiments, the mixing is performed until there is a substantially homogenous mixture of the fibers of the plant hurd material within the aqueous medium. By a “substantially homogeneous mixture of fibers”, it is meant that there is minimal agglomerations of the plant hurd material fibers (i.e. minimal chunks) and that the fibers are distributed substantially evenly throughout the aqueous medium such as, for example, in a suspension. In an embodiment, the mixing is for a time of at least 1 minute, at least 5 minutes, at least 10 minutes, at least 20 minutes, at least 30 minutes, at least 40 minutes, at least 50 minutes, or at least 60 minutes. In an embodiment, the mixing is for between about 1 minute and about 60 minutes, more particularly between about 1 minute and about 30 minutes, or about between about 1 minute and about 10 minutes.

The removing may be by any suitable means to form the hurd cake. In some embodiments, the removing may be by a continuous flow dewatering belt, a screen, a strainer, a sieve, a filter, flotation, or any combination thereof. In an embodiment, the removing is by a continuous flow dewatering belt. In an embodiment, the removing is by a screen.

In some embodiments, the hurd cake is in the form of a sheet. In an embodiment, the hurd cake is a sheet having a thickness of between about 0.5 mm and about 10 mm. In an embodiment, the hurd cake is a sheet having a thickness of about 0.5 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm. In a particular embodiment, the hurd cake is a sheet of a thickness of between about 1 mm and about 5 mm.

In some embodiments, the step of removing at least a portion of the aqueous medium to form a hurd cake comprises: transferring the mixture onto a screen, optionally where the screen is resting or submerged in a pool of the aqueous medium; allowing the aqueous medium to drain from the screen; and removing the plant hurd material from the screen to provide the hurd cake in the form of a sheet. By “optionally resting or submerged in a pool of the aqueous medium”, it is meant that the screen may be positioned within a volume of the aqueous medium, which may allow for more uniform distribution of the hurd cake.

The transferring may be done by any suitable means, such as pouring (directly onto the screen or indirectly by, for example, a transfer tube), ladling, or funnelling. The vessel from which the mixture was transferred and/or any equipment used in the transfer may optionally be rinsed with additional aqueous medium and the rinse transferred to the screen.

In an embodiment, the screen is resting or submerged in a pool of the aqueous medium, and the screen is agitated to evenly distribute the plant hurd material atop the screen. The agitation may be by any suitable means such as, for example, manual agitation or mechanical agitation. The screen may be removed from the pool of the aqueous medium by any suitable means, such as, for example, manual lifting or mechanical lifting. In an embodiment, the step of allowing the aqueous medium to drain from the screen comprises compressing the plant hurd material on the screen. In an embodiment, the step of removing at least a portion of the aqueous medium to form a hurd cake comprises rolling, pressing and/or tilting the plant hurd material. It will be appreciated that other techniques for manipulating the plant hurd material to remove at least a portion of the aqueous medium to form the hurd cake may be suitable.

The drying step of the methods disclosed herein may be by any suitable means to provide the high-absorbency hurd material. In some embodiments, the drying is by ambient evaporation or reduced-pressure evaporation. In some embodiments, the drying is by convection drying. In some embodiments, the drying uses a radio frequency dryer. More than one of the drying methods disclosed herein may be used in the drying step. In some embodiments, the drying is by combined radio frequency and hot air.

In some embodiments, the drying is at a temperature of between about 100° F. and about 400° F. In some embodiments, the drying is at a temperature of about 100° F., about 125° F., about 150° F., about 175° F., about 200° F., about 225° F., about 250° F., about 275° F., about 300° F., about 325° F., about 350° F., about 375° F., or about 400° F. The drying may be for any suitable time. In some embodiments, the drying is for a period of at least 1 minute, at least 5 minutes, at least 10 minutes, at least 20 minutes, at least 30 minutes, at least 40 minutes, at least 50 minutes, at least 60 minutes, at least 90 minutes, at least 120 minutes, at least 150 minutes, or at least 180 minutes. In a particular embodiment, the temperature is about 250° F. and the drying is for a period of at least 30 minutes.

In embodiments of the methods disclosed herein, the lignins are maintained within the high-absorbency hurd material and are not removed during the methods herein. It is contemplated that the lignins may dissociate from the hurd plant material during the methods herein, but are subsequently re-introduced or re-constituted within the high-absorbency hurd material during the process. It is also contemplated that the character or compositions of the lignins may change during the methods herein.

In some embodiments, the method for preparing a high-absorbency hurd material further comprises a step of chemical treatment of the plant hurd material to selectively skew absorbency towards lipophilic liquids over aqueous liquids. By “chemical treatment” it is meant that the plant hurd material is exposed to additional chemicals or other additives, and/or additional process steps that alter one or more properties of the plant hurd material. As used herein, the term “selectively skew absorbency” is intended to refer to controlling the physical and/or chemical properties of the plant hurd material for preferential absorption of either hydrophilic or hydrophobic materials.

In some embodiments, the step of chemical treatment comprises adding a modifying agent to the aqueous medium before, during or after admixture with the plant hurd material. As used herein, the term “modifying agent” is intended to refer to a chemical compound that will interact with and/or react with the plant hurd material to alter one or more properties of the plant hurd material. In an embodiment, that property is selective absorbency towards hydrophobic liquids. In an embodiment, the modifying agent causes the high-absorbency hurd material to exhibit an improved absorption capacity for a hydrophobic liquid (e.g. oil) in comparison a high-absorbency hurd material that has not been treated with the modifying agent. In some embodiments, the modifying agent causes the high-absorbency hurd material to exhibit a greater absorption capacity to a hydrophobic liquid (e.g. oil) than a hydrophilic liquid (e.g. water).

In some embodiments, the modifying agent is a polymer dispersion, a wax dispersion; a silicone dispersion; a styrene butadiene dispersion; a styrene acrylic; a fluorinated polymer; a nanocoating; a compound having an acetylated hydroxyl group (e.g. such as an acetylated cellulose), or any combination thereof. In an embodiment, the modifying agent is a compound capable of acetylating natural cellulose within the plant hurd material. As used herein, the term “polymer dispersion” is intended to refer to an aqueous mixture comprising high molecular weight polymer particles. In an embodiment, the modifying agent is an acrylic polymer or an acrylic resin. In a particular embodiment, the modifying agent is a Joncryl™ acrylic polymer emulsion. In another particular embodiment, the modifying agent is Joncryl™ 1915, Joncryl™ 1919, or Joncryl™ 1921.

### High-absorbency Hurd Material Products

In some embodiments, the present disclosure provides a high-absorbency hurd material prepared by the methods disclosed herein.

The high-absorbency hurd material prepared by the methods disclosed herein may exhibit an improved absorption capacity for the aqueous medium, a different aqueous medium, a lipophilic medium, or any combination thereof as compared to an untreated hurd material. The aqueous medium may be any aqueous medium, including any of those specifically disclosed herein. In an embodiment, the aqueous medium is water, saltwater, or urine. By “different aqueous medium”, it is intended to mean that the high-absorbency hurd material has an improved absorption capacity for an aqueous medium other than the one it was prepared with (e.g. if it was prepared with water, than another aqueous medium such as urine). As used herein, the term “lipophilic medium” is used interchangeably with “hydrophobic medium” and the terms encompass any lipophilic or hydrophobic liquid, including for example oils (whether petroleum or plant based).

As used herein, the term “improved absorption capacity” is intended to refer to an increased ability of the high-absorbency hurd material described herein to draw in or soak up any of the mediums described herein. The absorption capacity may be measured in any suitable manner, including as described in the examples herein. As an example, the absorption capacity may be measured relative to the weight of the starting material. Thus, if the starting hurd material has a weight of 5 g and the weight of the and after an absorbance study it has a weight of 15 g, the absorption capacity can be reflected as 300% ((15 g/5 g)*100) or it can be reflected as 3-fold or 3 times.

As used herein, by the term “untreated hurd material”, it is intended to refer to a hurd material that is not processed or treated in accordance with the methods of the present disclosure. For example, an untreated hurd material may be a dried, raw hurd material from a plant (e.g. from hemp). The untreated hurd material should be from the same plant species as the high-absorbency hurd material.

In some embodiments, the high-absorbency hurd material of the present disclosure exhibits an improved absorption capacity for both water and oil as compared to an untreated hurd material. In some embodiments, the improved absorption capacity of the high-absorbency hurd material is at least double that of the untreated hurd material. The oil may be any oil such as petroleum (fuels and lubricants), cooking oils, or oil-based products (e.g. paints). In an embodiment, the oil is a refined or unrefined petroleum.

In some embodiments, the present disclosure provides a high-absorbency hurd material that exhibits at least double the absorption capacity for an aqueous medium and/or a lipophilic medium as compared to a natural hurd material. As used herein, the term “natural hurd material” is meant to refer to plant hurd material that has not undergone the methods disclosed herein. In some embodiments, the high-absorbency hurd material is comprised of hemp hurd, jute hurd, kenaf hurd, ramie hurd, flax hurd, or any combination thereof. In a particular embodiment, the high-absorbency hurd material is comprised of hemp hurd.

The high-absorbency hurd materials provided by the methods disclosed herein may be of any shape and any size suitable for a given product and/or application. In some embodiments, the high-absorbency hurd material may be in the shape of a sheet, a pellet, a cube, a die-cut pattern, a bowl, a tray, a boom, a sock, a pan, a plate, a container insert, a folded box, or a tile. In some embodiments, the high-absorbency hurd materials are cut by a continuous die-cutter.

The high-absorbency hurd materials provided by the methods disclosed herein may be further processed to impart or improve additional properties. In some embodiments, the high-absorbency hurd material is lined with a scrim or other backing material to increase durability and/or even further improve the capability of materials being absorbed into the high-absorbency hurd materials. In some embodiments, the high-absorbency material is lined with a laminate, a film or other leakage blocking material to prevent leakage beyond the high-absorbency hurd material, to provide greater surface integrity and/or to provide dust control. The film may be any suitable film for preventing leakage or providing other functionalities, such as surface integrity. In a particular embodiment, the film is a biodegradable film.

In some embodiments, the high-absorbency hurd materials provided by the methods disclosed herein are subjected to the step of chemical treatment to selectively skew absorbency towards lipophilic liquids over aqueous liquids.

Without being bound by any particular theory the high-absorbency hurd materials disclosed herein may allow for use of a renewable natural resource, which may in turn contribute to lowering the carbon dioxide footprint attributed to producing other absorbent materials.

### Applications of High-absorbency Hurd Material

The properties of the high-absorbency hurd materials provided by the methods disclosed herein may have broad application in any situation in which it is desirable to absorb a liquid. The plant hurd material may be chosen based on a particular application, or not. In some embodiments, the high-absorbency hurd material is comprised of hemp hurd, jute hurd, kenaf hurd, ramie hurd, flax hurd, or any combination thereof. In some embodiments, the high-absorbency hurd materials disclosed herein are comprised of hemp hurd.

Advantageously, the increased absorption capacity may result in less mass of plant material being needed to absorb desired liquids (e.g. spills or urine), and thus less mass to recover during removal and disposal as well.

In some embodiments, the high-absorbency hurd materials provided by the methods disclosed herein may be used as for absorbing bodily fluids and/or excretions (e.g. urine). In an embodiment, the high-absorbency hurd material is used for an animal bedding, an animal litter, a diaper, a sanitary pad, or a clothing insert.

In some embodiments, the high-absorbency hurd materials provided by the methods disclosed herein are used as an oil spill remediation absorbent. In some embodiments, the high-absorbency hurd materials used as an oil spill remediation absorbent have undergone the step of chemical treatment to selectively skew absorbency towards lipophilic liquids over aqueous liquids. Thus, the high-absorbency hurd materials may be particularly well suited for oil spill remediation in bodies of water, whereby the high-absorbency hurd materials may preferentially absorb the oil before or at a greater capacity than the water. Further, oil laden hurd may be incinerated without concern for ash content, undesirable residue buildup or excessive temperature rise in the furnace, as may be experienced with traditional clays or polypropylene fibers.

In some embodiments, the high-absorbency hurd materials provided by the methods disclosed herein are used to collect the absorbed materials. For example, the high-absorbency hurd materials disclosed herein may be used to collect or capture oil or other lipophilic liquids and then compressed and used as a fuel pellet. In some embodiments, such fuel pellets maybe mixed or combined with clean or untreated hurd to provide a suitable fuel.

In some embodiments, the high-absorbency hurd materials provided by the methods disclosed herein are used as a carrier for animal waste and to be employed as a fertilizer.

In some embodiments, the high-absorbency hurd materials provided by the methods disclosed herein are used as a carrier for herbicides, insecticides, fungicides, biocides, oil-consuming bacterium, biostimulants, nutrients, or any combination thereof. In these embodiments, the high-absorbency hurd materials may have undergone the step of chemical treatment to selectively skew absorbency towards lipophilic liquids over aqueous liquids.

In some embodiments, the high-absorbency hurd materials provided by the methods disclosed herein are used as a slow release water retention system.

In other aspects of the present disclosure, the methods disclosed herein for preparing high-absorbency hurd materials may be used, in whole or in part, to prepare hurd products suitable as alternatives to balsa wood and products capable of being made from balsa wood. In addition, the balsa wood alternatives of the present disclosure may be used in any application for which balsa wood is typically used.

### Balsa-Like Wood Alternative Products

In some embodiments, the present disclosure relates to a balsa-like wood alternative product, the balsa-like wood alternative product comprising a plant hurd material, low-density spheres, and a binding agent.

As used herein, the term “natural balsa” is intended to refer to parts and/or the whole of the Ochroma pyramidale (balsa tree) plant. The use of the term “natural balsa” instead of “balsa” is intended to clarify and distinguish natural material of the balsa tree from the balsa-like wood alternative products disclosed herein.

As used herein, the term “cellulose” is intended to refer to an insoluble polysaccharide that comprises the majority of plant cell walls. Cellulose is a major constituent of hurd and plant hurd materials. The particular cell structure and cell arrangement of certain hurd celluloses (e.g. hemp) provides structural advantages to the products disclosed herein including but not limited to very low density. Typically, hurd comprises about 40-60% cellulose by weight, about 15-25% hemicellulose by weight, and about 20-20% lignin by weight of the dry hurd post pulping.

In an embodiment, the plant hurd material used in the balsa-like wood alternative products herein is from hemp, jute, kenaf, ramie, flax, or any combination thereof. In an embodiment, the plant hurd material is from hemp. In some embodiments, the plant hurd material is hurd material that has undergone decortication. By “decortication” or “decorticating”, it is intended to mean to separate the core or hurd from the plant material. In an embodiment, the plant hurd material comprises between about 60% and about 100% hurd by weight. In an embodiment, the plant hurd material comprises at least 75%, at least 80%, at least 85%, at least 90%, at least 95%, or greater hurd by weight. In an embodiment, the plant hurd material comprises at least 95% hurd by weight. In some embodiments, the plant hurd material comprises about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% hurd by weight. In an embodiment, the plant hurd material consists of 100% hurd by weight.

In an embodiment, the plant hurd material is hurd material that has undergone refining to provide hurd fibers with a uniform average particle size. By “refining”, it is intended to mean to apply mechanical forces on hurd fibers to reduce particle size to a uniform average distribution. A non-limiting example of how refining may be performed is by any one or more conventional pulping systems, such as for example an Andritz™ pulping system. In an embodiment, the fibers have a width:length ratio of about 1:5, 1:4, 1:3, 1:2, or 1:1. In some embodiments, the hurd fibers of the plant hurd material have an average particle size of about 0.2 inches by about 0.3 inches. In some embodiments, the hurd fibers of the plant hurd material has an average particle size of about 0.16 inches by about 0.28 inches, about 0.14 inches by about 0.26 inches, about 0.12 inches by about 0.24 inches, or about 0.10 inches by about 0.22 inches. In a particular embodiment, the hurd fibers of the plant hurd material has an average particle size of about 0.125 inches by about 0.25 inches.

As used herein, the term “low-density spheres” is intended to refer to small lightweight spheres that have low density per given bulk or volume as compared to other materials. Any suitable material that adds bulk wile lowering the overall density may be used. In an embodiment, the low-density spheres are microspheres or nanospheres. As used herein, “microspheres” are any organic or inorganic spherical particles having a diameter of between about 1 micron and about 1000 microns. A large array of materials may be used to produce microspheres, all of which are contemplated herein so long as they are compatible with the other components of the balsa-like wood alternative products herein.

In some embodiments, the low-density spheres may be polymeric microspheres, glass microspheres, ceramic microspheres, or any combination thereof. In an embodiment, the low-density spheres are polymeric microspheres. As used herein, the term “polymeric microspheres” is intended to refer to microspheres made from repeating units of a given material (e.g. polymers), including for example thermoplastic materials. In an embodiment, the polymeric microspheres are Prolite™ microspheres (The R.J. Marshall Company, USA). In a particular embodiment, the polymeric microspheres brand are Prolite™ Microsphere Filler Blend 130 polymeric microspheres. In an embodiment, the low-density spheres are added to the balsa-like wood alternative products under agitation.

As used herein, the term “binding agent” is intended to refer to a material or substance that aids in holding the plant hurd material together as a cohesive mixture. Certain binding agents may be particularly well-suited. For example, in an embodiment, the binding agent is selected from an acrylic resin, an acrylic emulsion, a polymer dispersion, a styrene resin, a styrene-butadiene dispersion, an epoxy resin, an epoxy powder, a polyester, a phenolic resin, a latex polymer, or any combination thereof.

In some embodiments, the binding agent comprises at least one dry epoxy powder and at least one latex polymer. In an embodiment, the at least one dry epoxy powder is an epoxy powder from Axalta Coating Systems (Axalta, USA). In an embodiment, the dry epoxy powder is Nap-Gard™ 7-5000 Biolink FBE (Axalta, USA). As the skilled person will know, epoxy (also known as polyepoxides) are a class of reactive polymers which contain epoxide groups. Any epoxy maybe used in the context of the present disclosure.

Latex polymers are well known in the art and have a wide range of properties. As used herein, the latex polymers may be natural or synthetic. In an embodiment, the latex polymers are a synthetic acrylic emulsion. In some embodiments, the latex polymers may contain functional groups such as alcohols, carboxylic acids, or amines to allow the at least one dry epoxy powder to bind the latex in addition to cellulose in the hurd material. In some embodiments, the latex polymer may be a reactive thermoset latex, a thermoplastic latex, or a combination thereof. In an embodiment, the at least one latex polymer is a water-based latex thermoplastic acrylic. In an embodiment, and without limitation, the latex polymer may from the Aquaset™ series (Dow Chemical Company, USA) or the Acrodur™ series (BASF Corp., USA). In an embodiment, the latex polymer may be AQUASET™ 100, AQUASET™ 110, AQUASET™ 200, ACRODUR™ 950L, ACRODUR™ PLUS 2580, ACRODUR™ DS 3515, ACRODUR™ DS 3558, ACRODUR™ Power 4444, acForm™, or any combination thereof.

In a particular embodiment, the binding agent may be a blend of two or more different agents. In an embodiment, the binding agent is a blend of a dry epoxy powder and a water-based latex thermoplastic acrylic. In an embodiment, the epoxy powder:latex polymer weight ratio in the blend is about 1:5, 1:4, 1:3, 1:2, 1:1, 2:1, 3:1, 4:1 or 5:1. In select embodiments, the epoxy powder:latex polymer weight ratio in the blend is between 1:5 and 1:1, more particularly between 1:3 and 1:1. In a particular embodiment, the epoxy powder:latex polymer weight ratio in the blend is about 1:2. In an embodiment, the latex polymer is included as-is (ranging in solids typically from 45-55%). In such as-is embodiments, a 1:2 weight ratio of the epoxy powder:latex polymer is about a 1:1 ratio of epoxy powder:latex polymer solids. Thus, in select embodiments, the balsa-like wood alternative products of the present disclosure comprise a nearly equal content by weight of epoxy and latex after removal of water from the intermediates described herein.

In an embodiment, the dry epoxy is included in the balsa-like wood alternative products of the present disclosure in an amount of about 34% by weight of cellulose weight in the product. In an embodiment, the latex polymer is included in the balsa-like wood alternative products of the present disclosure in an amount of about 32% by weight of cellulose weight in the product. In an embodiment, the dry epoxy is included in the balsa-like wood alternative products of the present disclosure in an amount of about 34% by weight of cellulose weight in the product. In embodiments herein, it was found that this provides suitable physical performance in flexural, tensile and compression properties to the balsa-like wood alternative products of the present disclosure.

In some embodiments, the balsa-like wood alternative product comprises between about 20% and about 75% by weight plant hurd material. In some embodiments, the balsa-like wood alternative product comprises between about 40% and about 60% by weight plant hurd material, more particularly between about 43% and about 58% by weight plant hurd material, and more particularly still between about 44% and about 55% by weight plant hurd material. In select embodiments, the balsa-like wood alternative product comprises about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60% by weight plant hurd material.

In some embodiments, the balsa-like wood alternative product comprises between about 10% and about 75% by weight of the binding agent. In some embodiments, the balsa-like wood alternative product comprises between about 40% and about 60% by weight of the binding agent, more particularly between about 42% and about 52% by weight binding agent, more particularly still between about 45% and about 51% by weight binding agent. In select embodiments, the balsa-like wood alternative product comprises about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60% by weight binding agent.

In some embodiments, the binding agent comprises a blend of an epoxy powder and a latex polymer. As above, in an embodiment the epoxy powder:latex polymer weight ratio in the blend is between about 1:5 and about 5:1. In an embodiment, the blend comprises between about 5% and about 25% by weight epoxy powder relative to total weight of the balsa-like wood alternative product. In an embodiment, the blend comprises between about 20% and about 40% by weight acrylic resin relative to total weight of the balsa-like wood alternative product.

In some embodiments, the balsa-like wood alternative product comprises between about 1% and about 25% by weight low-density spheres. In some embodiments, the balsa-like wood alternative product comprises between about 2% and about 15% by weight low-density spheres, more particularly between about 4% and about 10% by weight low-density spheres. In select embodiments, the balsa-like wood alternative product comprises about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, or about 25% by weight low-density spheres.

In an embodiment, the balsa-like wood alternative product comprises between about 20% and about 75% by weight of the plant hurd material; between about 1% and about 25% by weight of the low-density spheres; and between about 10% and about 75% by weight binding agent. In some embodiments, the balsa-like wood alternative product comprises between about 40% and about 60% by weight plant hurd material; between about 2% and about 15% by weight low-density spheres; and between about 40% and about 60% by weight binding agent.

In some embodiments, the balsa-like wood alternative product comprises about 46% by weight of the plant hurd material; about 9% by weight of the low-density spheres; and about 45% by weight of the binding agent. In an embodiment, of the 45% binding agent, about 14% is epoxy powder and about 27% is latex polymer.

In some embodiments, the balsa-like wood alternative product comprises: about 44% by weight plant hurd material; about 4% by weight low-density spheres; and about 51% by weight binding agent. In an embodiment, of the 51% binding agent, about 12% is epoxy powder, about 23% is latex polymer and about 16% is a styrene resin or a styrene-butadiene dispersion.

In some embodiments, the balsa-like wood alternative product comprises: about 49% by weight plant hurd material; about 5% by weight low-density spheres; and about 46% by weight binding agent. In an embodiment, of the 46% binding agent, about 15% is epoxy powder and about 31% is latex polymer.

The balsa-like wood alternative products of the present disclosure may be of any shape and size suitable for a given product and/or application. In some embodiments, the balsa-like wood alternative product is extruded to a pre-determined shape and size. In an embodiment, the pre-determined shape is a sheet, a pellet, a cube, a die-cut pattern, a bowl, a tray, a boom, a pan, a plate, a container insert, a folded box, a tile, a section of a wind turbine blade, a straight plank, or a curved plank.

In an embodiment, the balsa-like wood alternative product has a density of between about 8 lbs/ft³ and 12 lbs/ft³. In some embodiments, the balsa-like wood alternative product has a density of about 9 lbs/ft³, about 10 lbs/ft³, or about 11 lbs/ft³. In an embodiment, the balsa-like wood alternative product has a density of about 10 lbs/ft³.

In some embodiments, the balsa-like wood alternative product may comprises one or more additives. Any suitable additive may be included. In an embodiment, the balsa-like wood alternative product may further comprises a flame retardant, an adhesive, a coloring agent, a fragrance agent, a hydrophobic ingredient, an enzyme, a wetting agent, an anti-static agent, a bactericide, a fungicide, a filler, a UV stabilizer, a rust inhibitor, or any combination thereof.

In some embodiments, the present disclosure further relates to a balsa-like intermediate product. The balsa-like intermediate product is a product that may be used to make the balsa-like wood alternative of the present disclosure, for example by drying the intermediate to provide the balsa-like wood alternative product.

In an embodiment, a supplier or manufacturer may provide the balsa-like intermediate product to a consumer, and it is the consumer that prepares the balsa-like wood alternative product. In other embodiments, the balsa-like intermediate product is used by the supplier or manufacturer themselves to prepare and provide the balsa-like wood alternative product to the consumer.

The balsa-like intermediate product of the present disclosure comprises a plant hurd material, low-density spheres, a binding agent, and at least 5% by weight of an aqueous medium. The plant hurd material, low-density spheres, and a binding agent are as described elsewhere herein. Likewise, embodiments of aqueous mediums are described elsewhere herein in the context of the high-absorbency hurd materials. In an embodiment, the aqueous medium is water.

In some embodiments, the balsa-like intermediate product comprises between about 5% and about 20% by weight of the aqueous medium, more particularly between about 8% and about 18% by weight of the aqueous medium, more particularly still between about 10% and about 15% by weight of the aqueous medium. In select embodiments, the balsa-like intermediate product comprises about 5%, about 6%, about 7%, about 8%, about 9%, about 10%, about 11%, about 12%, about 13%, about 14%, about 15%, about 15%, about 17%, about 18%, about 19%, or about 20% by weight of an aqueous medium.

With respect to the by weight amount of the plant hurd material, low-density spheres, and binding agent in the balsa-like intermediate product herein, the amounts are as described herein with respect to the balsa-like wood alternative products, adjusted to take into account the presence of the aqueous medium (e.g. water).

In an embodiment, the balsa-like intermediate product of the present disclosure comprises the aqueous medium at an amount of between about 35% and about 50% by weight of cellulose weight in the product. In some embodiments, the balsa-like intermediate product of the present disclosure comprises the aqueous medium at an amount of about 35%, about 36%, about 37%, about 38%, about 39%, about 40%, about 41%, about 42%, about 43%, about 44%, or about 45% by weight of cellulose weight in the product. In a particular embodiment, the balsa-like intermediate product of the present disclosure comprises the aqueous medium at an amount of about 40% by weight of cellulose weight in the product.

In an embodiment, the balsa-like intermediate product of the present disclosure comprises between about 20% and about 75% by weight of the plant hurd material; between about 1% and about 25% by weight of the low-density spheres; between about 10% and about 75% by weight binding agent; and between about 5% and about 20% of the aqueous medium.

In an embodiment, the balsa-like intermediate product of the present disclosure comprises between about 30% and about 60% by weight of the plant hurd material; between about 2% and about 15% by weight of the low-density spheres; between about 30% and about 50% by weight binding agent; and between about 8% and about 18% of the aqueous medium.

In an embodiment, the balsa-like intermediate product of the present disclosure comprises between about 35% and about 45% by weight of the plant hurd material; between about 5% and about 10% by weight of the low-density spheres; between about 35% and about 45% by weight binding agent; and between about 10% and about 15% of the aqueous medium.

In the methods herein for preparing the balsa-like wood alternative of the present disclosure, the aqueous medium (e.g. water) is added to the plant hurd material prior to the binding agent. Without being bound by theory, the water assists in allowing the binding agent to evenly coat the surface and provide consistent fiber binding throughout the composite. In an embodiment, it has advantageously been found to add the water as a fine mist with blending agitation.

### Methods for Preparing Balsa-Like Wood Alternative Products

In an embodiment, the present disclosure relates to a method for preparing a balsa-like wood alternative product, the method comprising: providing a plant hurd material comprising at least 75% hurd by weight; combining the plant hurd material with an aqueous medium to provide a hydrated hurd mixture; combining, in any order, the hydrated hurd mixture with low-density spheres and one or more binding agents to provide a balsa-like intermediate product; and drying the balsa-like intermediate product to provide the balsa-like wood alternative product.

In some embodiments, the step of providing the plant hurd material comprises decorticating a plant material to separate a hurd component from the plant material. In an embodiment, the plant hurd material comprises at least 80% hurd by weight, more particularly at least 95% hurd by weight. In some embodiments, the plant hurd material comprises about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% hurd by weight. In an embodiment, the plant hurd material consists of 100% hurd by weight.

In some embodiments, the hurd material is pulped into fine particles, for example using conventional paper pulping equipment. In some embodiments, the hurd material is pulped to achieve a particular architecture of fibers (length to width). For example, in such embodiments, the fibers are not pulverized into a powder, but rather demonstrate a particular aspect ratio of length to width. In an embodiment, the fibers have a width:length ratio of about 1:5, 1:4, 1:3, 1:2, or 1:1. In some embodiments, the hurd fibers have an average particle size of about 0.2 inches by about 0.3 inches. In some embodiments, the hurd fibers of the plant hurd material has an average particle size of about 0.16 inches by about 0.28 inches, about 0.14 inches by about 0.26 inches, about 0.12 inches by about 0.24 inches, or about 0.10 inches by about 0.22 inches. In a particular embodiment, the hurd fibers of the plant hurd material has an average particle size of about 0.125 inches by about 0.25 inches.

In some embodiments, the step of combining the plant hurd material with the aqueous medium comprises mixing the aqueous medium into the plant hurd material to hydrate cellulose within the plant hurd material. In some embodiments, the aqueous medium is water. The combining may be by any suitable means. In an embodiment, the combining is by mixing, such as for example stirring, blending, agitating, or shaking. In an embodiment, the combining is by spraying, for example by a spray nozzle in a Blow-Line configuration.

In an embodiment, the step of combining the plant hurd material with the aqueous medium comprises agitating the plant hurd material and spraying the aqueous medium onto the plant hurd material during the agitation. The spraying may be by any suitable means. In an embodiment, the aqueous medium is sprayed onto the plant hurd material as a fine mist.

In an embodiment, the step of combining the plant hurd material with the aqueous medium may be as described elsewhere herein in relation to producing the high-absorbency hurd material, including the application of heating. In other embodiments, the plant hurd material used to prepare the balsa-like wood alternative products is a high-absorbency hurd material as described herein, and this high-absorbency hurd material may be used as a starting material in the methods to prepare the balsa-like wood alternative products.

In an embodiment, the step of combining the plant hurd material with the aqueous medium comprises providing the aqueous medium at an amount of between about 35% and about 50% by weight of cellulose weight in the plant hurd material. In some embodiments, the balsa-like intermediate product of the present disclosure comprises the aqueous medium at an amount of about 35%, about 36%, about 37%, about 38%, about 39%, about 40%, about 41%, about 42%, about 43%, about 44%, or about 45% by weight of cellulose weight in the product. In a particular embodiment, the balsa-like intermediate product of the present disclosure comprises the aqueous medium at an amount of about 40% by weight of cellulose weight in the product.

In an embodiment, the step of combining the plant hurd material with the aqueous medium comprises providing the aqueous medium at an amount of between about 10% and about 60% by weight of the plant hurd material, more particularly between about 20% and about 50% by weight of the plant hurd material, more particularly still between about 30% and about 50% by weight of the plant hurd material. In select embodiments, the step of combining the plant hurd material with the aqueous medium comprises providing the aqueous medium at an amount of about 10%, about 15%, about 20%, about 25%, about 30%, about 35%, about 40%, about 45%, about 50%, about 55%, or about 50% by weight of the plant hurd material.

In some embodiments, the step of combining the plant hurd material with the aqueous medium comprises providing the aqueous medium at an amount of between about 5% and about 20% by weight of the final weight of the balsa-like intermediate product, more particularly between about 8% and about 18% by weight of the final weight of the balsa-like intermediate product, more particularly still between about 10% and about 15% by weight of the final weight of the balsa-like intermediate product. In select embodiments, the step of combining the plant hurd material with the aqueous medium comprises providing the aqueous medium at an amount of about 5%, about 6%, about 7%, about 8%, about 9%, about 10%, about 11%, about 12%, about 13%, about 14%, about 15%, about 15%, about 17%, about 18%, about 19%, or about 20% by weight of the final weight of the balsa-like intermediate product.

After the hydrated hurd mixture is formed in the methods herein, the low-density spheres and one or more binding agents may be added in any order. In an embodiment, low-density spheres are added prior to the one or more binding agents. In another embodiment, the low-density spheres and one or more bindings agents are added at the same time, either having been pre-mixed beforehand or added separately. In another embodiment, the one or more bindings agents are added prior to the low-density spheres. When more than one binding agent is used, each binding agent may be added separately or together, at the same or different times. When more than one type of low-density spheres are used, each type may be added separately or together, at the same or different times.

As with the aqueous medium, the combining of the low-density spheres and one or more binding agents with the hydrated hurd materials may be by any suitable means. In an embodiment, the combining is by mixing, such as for example stirring, blending, agitating, or shaking. In an embodiment, the combining is by spraying, for example by a spray nozzle in a Blow-Line configuration

In some embodiments, the step of combining the hydrated hurd mixture with the low-density spheres and the one or more binding agents comprises mixing the hydrated hurd mixture with the low-density spheres to provide a low-density hurd mixture; and mixing the low-density hurd mixture with the one or more binding agents to provide the balsa-like intermediate product.

In some embodiments, the combining steps are performed until substantially homogenous mixtures are provided. By “substantially homogenous mixtures”, it is meant that there are minimal agglomerations (i.e. minimal chunks) and that the components are distributed substantially even to comprise a suspension. In some embodiments, the combining steps comprise a high shear mixing (e.g. blending), shaking, or stirring. In a particular embodiment, the combining steps comprise high shearing mixing.

In some embodiments, the step of mixing the hydrated hurd mixture with the low-density spheres comprises providing an amount of low-density spheres at between about 1% and about 40% by weight of the hydrated hurd material, more particularly between about 5% and about 20% by weight of the hydrated hurd material, more particularly still between about 5% and about 15% by weight of the hydrated hurd material. In an embodiment, the step of mixing the hydrated hurd mixture with the low-density spheres comprises providing an amount of low-density spheres of about 1%, about 5%, about 6%, about 7%, about 8%, about 9%, about 10%, about 11%, about 12%, about 13%, about 14%, about 15%, about 16%, about 17%, about 18%, about 19%, or about 20% by weight of the hydrated hurd material.

In some embodiments, the step of mixing the hydrated hurd mixture with the one or more binding agents comprises providing an amount of the binding agents (combined total if more than one) at between about 50% and about 100% by weight of the hydrated hurd material, more particularly between about 60% and about 90% by weight of the plant hurd material, more particularly still between about 70% and about 80% by weight of the plant hurd material. In an embodiment, the step of mixing the hydrated hurd mixture with the one or more binding agents comprises providing an amount of the binding agents (combined total if more than one) of about 50%, about 55%, about 60%, about 65%, about 70%, about 75%, about 80%, about 85%, about 90%, about 95%, or about 100% by weight of the hydrated hurd material.

The balsa-like intermediate product may be dried by any suitable means. In some embodiments, the step of drying the balsa-like intermediate product comprises steps of pressing, heating, curing and cooling.

In an embodiment, the step of drying the balsa-like intermediate product comprises pressing the balsa-like intermediate product into a balsa-like cake; heating the balsa-like cake to one or more temperatures between about 120° C. and about 180° to dry the balsa-like cake; curing the dried balsa-like cake at a temperature between about 160° C. and 180° C.; and cooling the cured balsa-like cake to between about 15° C. and about 30° C. to provide the balsa-like wood alternative product. In an embodiment, the balsa-like intermediate product is not heated above 100° C. until most of the moisture is pressed out of the cake.

In an embodiment, pressing of the balsa-like intermediate product may be to a thickness of between about 0.25 inches and about 2.0 inches, more particularly between about 0.5 inches and about 1 inch. In a particular embodiment, the pressing is to the approximate thickness of a composite board at about 0.5 inches. In an embodiment, one or more of the pressing steps are heated. In an embodiment, one or more of the pressing steps are at a temperature of between about 120° C. and about 165° C. In an embodiment, the temperature is about 165° C. Each step of pressing may be for a suitable length of time, such as for example between about 5 minutes and about 30 minutes. In an embodiment, the pressing is for about 10 minutes. The pressing may be by any suitable means to form a balsa-like cake. In some embodiments, the pressing may be by a hammer or a Teflon coated press.

In some embodiments, the step of drying the balsa-like intermediate product comprises heating. The heating may be by any suitable means, including conduction heating, convection heating, radio frequency drying, or electromagnetic (radiation) heating. Also, in a Blow-Line process, material can be flash dried as the pathway is increased in diameter and the pressure changes quickly. In an embodiment, at least a portion of the heating step is under pressure. In some embodiments, the heating temperature is between about 130° C. and about 170° C. In some embodiments, the heating temperature is at about 135° C., about 140° C., about 145° C., about 150° C., about 155° C., about 160° C., or about 165° C. In a particular embodiment, the heating is at a temperature of at most 165° C.

By “curing”, it is meant that the binding agent hardens, such as for example through cross-linking of polymer chains, changing from a liquid to a solid. The curing may be by any suitable means, including conducting heating, convection heating, radio frequency drying, or electromagnetic (radiation) heating. In an embodiment, at least a portion of the curing step is under pressure. In some embodiments, the heating temperature is between about 165° C. and about 175° C. In some embodiments, the heating temperature is at about 167° C., about 169° C., about 171° C., or about 173° C. In a particular embodiment, the curing is at a temperature of at most 165° C.

In an embodiment, drying of the balsa-like intermediate product may include steps of heating and curing. In an embodiment, none of the heating or curing steps are above 165° C. so as to avoid damage to the low-density spheres (e.g. polymeric microspheres).

After drying, the product is cooled to obtain the balsa-like wood alternative product. The cooling may be by allowing the product to rest at ambient temperature or by other suitable means. In an embodiment, the cooling may be by a refrigerator, a fan, a freezer, or other means. In some embodiments, the balsa-like wood alternative product balsa-like wood alternative product is cooled to between about 20° C. and about 25° C. In some embodiments, the balsa-like wood alternative product balsa-like wood alternative product is cooled to about 21° C., about 22° C., about 23° C., or about 24° C.

In an embodiment, the steps of combining the materials, pressing, heating and/or cooling may occur on a continuous production line. In an embodiment, the continuous production line uses Blow-Line systems for combining components, combinations of radio frequency drying and conventional heating, and cooling utilizing a twin belt, Teflon coated press. As the plant hurd material is processed and combined with other components, it may be gravimetrically added to a belt and the width and girth of the composite set. Drying, heating and cooling zones may be implemented and set accordingly. The balsa-like wood alternative product may be cross-cut, stacked and packaged as desired.

In some embodiments, after drying, the balsa-like wood alternative product comprises between about 20% and about 75% by weight of the plant hurd material; between about 1% and about 25% by weight of the low-density spheres; and between about 10% and about 75% by weight binding agent.

In some embodiments, after drying, the balsa-like wood alternative product comprises: between about 40% and about 60% by weight plant hurd material; between about 2% and about 15% by weight low-density spheres; and between about 40% and about 60% by weight binding agent.

The methods herein have the ability to formulate a very low bulk density formulation that when chemically bonded creates a relatively high compression strength composite that retains its low-density properties.

In an embodiment, the present disclosure relates to a balsa-like wood alternative product prepared by the methods as disclosed herein.

By adjusting the methods disclosed herein towards higher-density products, such as by not including any low-density spheres and/or by increasing the quantity or proportion of plant hurd material within the final products, it is possible to provide alternatives to MDF (Medium Density Fiberboard).

In a particular embodiment, the present disclosure provides a lighter-weight MDF-type material by not including low-density spheres and by using only latex polymer (thermoplastic resin) as the binding agent. The lighter-weight MDF product was found to be capable of forming into moldable shapes at a later time after its production (see Example 9).

In an embodiment, the lighter-weight MDF-type materials of the present disclosure comprises plant hurd material and latex polymer. In an embodiment, the lighter-weight MDF-type material of the present disclosure comprises about 54% by weight plant hurd material and about 46% by weight latex polymer binding agent. In an embodiment, the lighter-weight MDF-type material may be produced according to the methods described herein for producing a balsa-like wood alternative product, with the exception that no low-density spheres are used and only a latex polymer is used as a binding agent. In an embodiment of the methods for producing the lighter-weight MDF-type material, the hydrated hurd material that is formed comprises about 70% by weight plant hurd material and about 30% by weight water. In an embodiment of the methods for producing the lighter-weight MDF-type material, the step of mixing the hydrated hurd mixture with the latex polymer binding agent comprises providing an amount of the latex polymer binding agent at about 52% by weight of the hydrated hurd material.

In a particular embodiment, the present disclosure provides an MDF alternative material by not including low-density spheres and by using only thermoset resin as the binding agent. The MDF alternative product was not moldable like the lighter-weight MDF-type material described above (see Example 10).

In an embodiment, the MDF alternative material of the present disclosure comprises plant hurd material and a thermoset resin (e.g. Acrodur™). In an embodiment, the MDF alternative material of the present disclosure comprises about 53% by weight plant hurd material and about 47% by weight thermoset resin binding agent. In an embodiment, the MDF alternative material may be produced according to the methods described herein for producing a balsa-like wood alternative product, with the exception that no low-density spheres are used and only a thermoset resin is used as a binding agent. In an embodiment of the methods for producing the MDF alternative material, the hydrated hurd material that is formed comprises about 70% by weight plant hurd material and about 30% by weight water. In an embodiment of the methods for producing MDF alternative material, the step of mixing the hydrated hurd mixture with the latex polymer binding agent comprises providing an amount of the thermoset resin binding agent at about 61% by weight of the hydrated hurd material.

### Applications of Balsa-Like Wood Alternative Products

The balsa-like wood alternative products of the present disclosure are capable of broad application in any situation in which it is desirable to use natural balsa wood. The plant hurd material may be chosen based on a particular application, or not. In some embodiments, the balsa-like wood alternative product is comprised of hemp hurd, jute hurd, kenaf hurd, ramie hurd, flax hurd, or any combination thereof. In some embodiments, the balsa-like wood alternative products disclosed herein are comprised of hemp hurd.

Advantageously, the high compression strength and low density of balsa-like wood alternative products may allow for use as an alternative to natural balsa wood in specific products or applications where natural balsa wood was considered ideal. For example, engineers designing turbine blades and boat structures utilize balsa as a foundation for applying (layering) fiberglass and epoxy, phenolic or styrene resins to create a super-strong construction. Natural balsa, or the balsa-like wood alternative products of the present disclosure, creates a sandwich panel construction that provides sufficient girth to increase flexural strength significantly. The requirement of natural balsa is not to add strength but to be strong enough to withstand vacuum pressure (compression strength) while the resin and fiberglass cures, and the balsa-like wood alternative product of the present disclosure may also be useful for this purpose.

In some embodiments, the balsa-like wood alternative product provided by the methods disclosed herein may be used as a core material in composites, laminates, or between sheets of carbon-fiber-reinforced plastic.

In some embodiments, the balsa-like wood alternative product provided by the methods disclosed herein may be used as a wind turbine blade (or component thereof), a surfboard, a deck board, or a component of a boat, or a component of an automobile. In an embodiment, the component of the boat is a topside component selected from a wall or a floor. In an embodiment, the component of the automobile is an interior component selected from a trim piece (e.g. dashboard, door, etc.) or a headliner.

In certain applications, as an additional functional requirement, the final panel cannot absorb too much resin. The end application requires the application of fiberglass/styrene resin to the panel surfaces to build strength. If the styrene resin absorbs excessively, the resin is drawn away from the panel surface, the overall density builds, and construction costs increase. In some embodiments of the present disclosure, the balsa-like wood alternative product includes latex polymers as binding agents to resist water intrusion and also resist styrene absorption. The use of latex polymers in the methods described herein were found to create a water-resistant barrier to the outside environment that works in tandem with the blended epoxy and latex polymer binding agents. Advantageously, this binding agent system was found to be sufficiently non-polar, but also contain enough carboxylic acid functionality, to also cross-link effectively with each other and the cellulose in the plant hurd material.

Having regard to the disclosure herein pertaining to the high-absorbency hurd materials, it is also contemplated to introduce possible deterrents to styrene or epoxy absorption into the balsa-like wood alternative products, such as for example and without limitation, Styronal ND 811, Joncryl HPB 4010 and Acronal NX 4787 (BASF Corp, USA). Studies conducted (data not included) show good efficiency.

Other applications of the balsa-like wood alternative products provided by the methods disclosed herein will be obvious to the skilled person in view of the teachings of the present disclosure.

### EXAMPLES

The following examples are included to demonstrate various embodiments of the present disclosure. It should be appreciated by those of skill in the art that the techniques disclosed in the examples that follow represent techniques discovered by the inventors to function well in the practice of the present disclosure, and thus may be considered to constitute preferred modes for its practice. However, those of skill in the art should, in light of the present disclosure, appreciate that many changes can be made in the specific embodiments which are disclosed and still obtain a like or similar result without departing from the scope of the present disclosure.

### Example 1

In this example, a method is described for improving the absorption capacity of hemp hurd for water.

A sample of dry hemp hurd was placed in a container and topped with boiling water. After about 10 minutes, the hurd and hot water were blended until a mixture was obtained that was substantially free of large chunks. The mixture was poured onto a screen situated within a frame and resting in a pool of water. The frame/screen was agitated to provide a uniform blend of hurd atop the screen within the frame. The frame/screen was then removed from the pool of water, thereby capturing the hurd fibers onto the screen. After allowing the water to drain, the layer of hurd was removed from the screen by applying a support on top of the layer of hurd and flipping gently. A roller was then applied over the screen with the screen and layer of hurd tilted, so as to allow any excess water to drain. The screen was then gently removed to provide a layer of hurd. The layer of hurd was dried at about 250° F. for about 60 minutes. Afterwards, the hurd sheet was stored until desired to be used. The hurd sheet was about 2 mm thick.

To test the water absorption capacity, the processed hurd sheet was cut into roughly 1.0″ squares. About 20 g of processed hurd sheet sample was placed into a bag. In another bag, about 20 g of untreated hemp hurd was added. Each of the bags were submerged in a container of room temperature water for about 30 seconds. The bags were then removed from the water and allowed to drain for about 90 seconds. Each bag was then weighed and the starting weight of the bag and sample was subtracted from the total weight to obtain the weight of water retained within the hemp hurd samples. The absorption capacity for water was then calculated by the following:

$$\frac{weight of absorbed water in grams}{weight of hurd in grams} \times 100$$

It was found that the absorption capacity for water of untreated hurd was 350% relative to the weight of the untreated hurd. For the hemp hurd processed according to the present disclosure (as described above), the absorption capacity for water was found to increase significantly to 786% relative to the weight of the untreated hurd.

To test the oil absorption capacity, the processed hurd sheet was cut into roughly 1.0″ squares. About 20 g of processed hurd sheet sample was placed into a bag. In another bag, about 20 g of untreated hemp hurd was added. Each of the bags were submerged in a container of room temperature oil (SAE 5W30) for about 30 seconds. The bags were then removed from the oil and allowed to drain for about 5 minutes. Each bag was then weighed and the starting weight of the bag and sample was subtracted from the total weight to obtain the weight of oil retained within the hemp hurd samples. The absorption capacity for oil was then calculated by the following:

$$\frac{weight of absorbed oil in grams}{weight of hurd in grams} \times 100$$

It was found that the absorption capacity for oil of untreated hurd was 293% relative to the weight of the untreated hurd. For the hemp hurd processed according to the present disclosure (as described above), the absorption capacity for oil was found to increase significantly to 810% relative to the weight of the untreated hurd.

### Example 2

In this example, a method is described for selectivity manipulating the absorption capacity of hemp hurd to skew absorbency toward lipophilic liquids.

A sample of dry hemp hurd was placed in a container and topped with boiling water. After about 5-10 minutes, the hurd and hot water were blended until a mixture was obtained that was substantially free of large chunks. Additional hot water was added if necessary. After a substantially uniform mixture was obtained, Joncryl 1921 (BASF″) was added at a concentration of about 0.04 g/ml. The mixture was blended for another minute or so to evenly distribute the Joncryl 1921. The mixture was then poured onto a screen situated within a frame and resting in a pool of water. The frame/screen was agitated to provide a uniform blend of hurd atop the screen within the frame. The frame/screen was then removed from the pool of water, thereby capturing the hurd fibers onto the screen. After allowing the water to drain, the layer of hurd was removed from the screen by applying a support on top of the layer of hurd and flipping gently. A roller was then applied over the screen with the screen and layer of hurd tilted, so as to allow any excess water to drain. The screen was then gently removed to provide a layer of hurd. The layer of hurd was dried at about 250° F. for about 120-180 minutes. Afterwards, the hurd sheet was stored until desired to be used.

To analyse absorption selectivity, a sample of the processed hemp hurd was tested for both water and oil absorption. It was found that 8.89 g of the processed hemp hurd absorbed 24.26 g of water. This represents an absorption capacity of 273%, which is a reduction of about 65% as compared to hemp hurd prepared according to Example 1. In contrast, it was found that 5.92 g of the processed hemp hurd absorbed 38.81 g of oil. This represents an absorption capacity of 656%, which is only a 19% reduction as compared to hemp hurd prepared according to Example 1. Notably, the weight of oil absorbed by the processed hemp hurd was over twice that of water, indicating a selectivity of hemp hurd processed according to this example for absorbing oil over water. Also, the absorption capacity for water was less than the untreated hurd (Example 1).

### Example 3

The study of Example 2 was repeated with the exception that Joncryl 1921 (BASF″) was added at a concentration of about 0.004 g/ml (as opposed to 0.04 g/ml). With the adjusted concentration of Joncryl 1921, it was found that the absorption capacity of the processed hemp hurd for water was 545%. This represents a reduction of about 30% as compared to hemp hurd prepared according to Example 1.

### Example 4

Hemp core product is processed through a hammer mill system with a set screen value to provide more uniform product size (e.g. roughly ⅛″×¼″ in size). This is important to support continuity of downstream thermal processing of hurd fiber.

After particle size reduction, the hurd is stored in an upright cylinder tower having a capacity to buffer a production rate of 200 pounds of hurd material per minute. For this experiment, towers have a capacity of 5,000 gallons each.

At the bottom of the buffer dry tank is a rotary feed valve which, via a load cell scale, controls the desired feed rate of hurd as it enters the production line. This ensures continuity in process cycle time as it occurs in each of the different process steps in the system.

Fed from the end of the load cell conveyor, hurd is gravity dropped into a feed auger that moves hurd into a continuous heating system where the hurd is exposed to boiling water for period up to 10 minutes under constant stir to make sure all hurd is submerged directly into water for proper cooking. This is a key phase of fiber preparation for influencing absorbency, rebonding of slurry via dissolved lignin, and extrusion of products in into a desired shape profile prior to oven drying. Another key factor in boiling the hurd is to ensure the all-natural lignins have transmission from solid state to a liquid or softened state prior to redrying.

After a period of continuous cooking, the soft and moisture laden hurd material is placed into a high shear blender to impart a change in the structure of the hurd from a woody substance to a product similar to pulp wood for making paper. In this step, softened or dissolved lignin is removed from the hurd structure of fibers. Some of this lignin is removed during water replacement while some is recycled back to cook tank. Exposure to high-speed high shear blending is around 5 minutes. Without being bound to any particular theory, it is believed that this step also provides for distribution of lignin in the product, which is relevant to providing in-situ bonding between fibers during reconstruction into a saleable shape and product.

Once proper particle size reduction is achieved, which can take up to five minutes in continuous flow, the process slurry then enters a dewatering system where as much water is removed as possible on a continuous system, such as for example via dewater belts or dewater screw conveyor. Removed water is recovered and returned to the first stage cooking system with part water being removed and replenished with fresh water.

After dewatering, the product enters into a continuous paddle blender where additives are added to change the absorption characteristics to provide high-absorbency hurd materials of the present disclosure or to impart the characteristics to provide a ‘balsa-like’ hurd product.

For a high-absorbency hurd material with a selectively skewed absorbency for hydrophobic liquids, a small amount of a modifying agent, such as a Joncryl™ acrylic polymer emulsion (e.g. Joncryl™ 1919, or Joncryl™ 1921) is added, allowing use of the high-absorbency hurd material on aqueous liquid surfaces to remove hydrocarbons, while not exhibiting high absorption capacity to the water.

For a high-absorbency hurd material having improved water absorption capacity, the modifying agent in the preceding paragraph is not used. For example, no modifying agents are added.

For a ‘balsa-like’ hurd material, the high-absorbency hurd material may be used or it may include further additives, such as flame retardants to achieve multiple levels of UL requirements (including meeting UL94 VO) or biocides to prevent fungal growth. In addition, adhesive materials may be added, if desired, to as well as adding in additional adhesive materials if we want to bolster product flexural modulus strength to higher than natural balsa.

Optionally, shape profile extrusion may be performed on any of the products. For example, the products may be extruded to a pre-determined shape using a profile die at end of extruder. Multiple ribbons of the high-absorbency hurd material can flow from a single die, cut to length using a high-speed wire cutter and then through a radio frequency drying oven to remove all moisture prior to exiting into per determined packaging stage.

The balsa-like hurd material may also be extruded to shape, including the size and shape for manufacturing wind turbine blades. Similarly, once extruded the shape can be wire cut to length and dried using same radio frequency drying oven before final packaging.

In both products, without being bound to any particular theory, it is believed that the natural dissolved lignin becomes the primary bonding agent that glues the fine fibers back together allowing product to hold shape post extrusion.

### Example 5

In this example, an exemplary method is described for preparing a balsa-like wood alternative product of the present disclosure.

The procedure of Example 4 was used to prepare a dewatered hemp hurd product with suitable particle size.

A sample of the dewatered hemp hurd was placed into a high shear blender and agitated. Water was added as a fine mist to the dewatered hemp hurd at an amount of about 40% by weight of cellulose weight of the dewatered hemp hurd. Prolite™ Microsphere Filler Blend 130 polymeric microspheres (The R.J. Marshall Company, USA) were then added to the mixture under agitation at an amount of about 20% by weight of cellulose weight of the dewatered hemp hurd.

To prepare a suitable binding agent, two types of resins were combined to provide a blend, namely an epoxy powder (Axalta, USA) was mixed with a latex acrylic (BASF SE, USA) at a ratio of about 1:2 by weight. The epoxy powder was used in dry form and in this example was Nap-Gard™ 7-5000 Biolink FBE, whereas the latex acrylic was used as provided from the supplier with solids concentration typically ranging from 45-55% by weight of the latex acrylic weight. The binding agent was then mixed with the prepared hydrated hurd material containing polymeric microspheres at an amount of about 34% by weight of cellulose weight of the dewatered hemp hurd under high shear mixing to form a balsa-like intermediate product.

The balsa-like intermediate product (a homogenous mixture) was pressed, without heating and with a gap set for 0.5″, into a loose cake. The loose cake was transferred to a heated press and pressed at a temperature of about 165° C., for about 9 minutes, to firm up the cake. To dry the cake, the cake removed from the press and placed into an oven set at about 135° C. for about 20 minutes. The dried cake was then returned to the heated press set at about 165° C. and pressed again for about 9 minutes, removed, and allowed to cool to ambient temperature to provide a balsa-like wood alternative product (composite) of the present disclosure. This product was trimmed to a desired sheet size.

The balsa-like wood alternative product was found to be a reliable replacement to natural balsa wood, including having suitable flexural strength, high compression strength, and retaining low-density/light-weight characteristics. Also, the sheet of the balsa-like wood alternative product of the present disclosure exhibited suitable characteristics absorption of fiberglass/styrene resins. If a product absorbs too much resin, the resin becomes drawn away from the product surface and internalized within the product, increasing its overall density, and thereby construction costs increase and suitability for use in certain desired applications decreases. The balsa-like wood alternative product of this example had suitable absorption characteristics to act as a reliable replacement for natural balsa wood.

### Example 6

In this example, the process of Example 5 was repeated using the following amounts and materials: (i) about 50.1 g of dewatered hemp hurd, (ii) about 10.6 g of water, (iii) about 10 g of Prolite™ Microsphere Filler Blend 130 polymeric microspheres, (iv) about 16.1 g of epoxy powder, and (v) about 32.3 g of acResin™ latex acrylic hot-melt polymer.

The balsa-like intermediate product thus comprised:

| | Percent Amount |
|---|---|
| Component | By Weight |
| Plant Hurd Material | 42% |
| Water | 9% |
| Polymeric Microspheres | 8% |
| Epoxy Powder (pre-mixed into latex polymer) | 14% |
| Latex Polymer | 27% |

The balsa-like intermediate product was pressed, heated and dried as described in Example 5. The balsa-like wood alternative product comprised:

| | Percent Amount |
|---|---|
| Component | By Weight |
| Plant Hurd Material | 46% |
| Polymeric Microspheres | 9% |
| Epoxy Powder | 15% |
| Latex Polymer | 30% |

This product was trimmed to a desired sheet size.

As in Example 5, the balsa-like wood alternative product of this example was found to be a reliable replacement to natural balsa wood, including having suitable flexural strength, high compression strength, retaining low-density/light-weight characteristics, and displaying suitable absorption characteristics in respect of fiberglass/styrene resins.

### Example 7

In this example, the process of Example 5 was repeated using the following amounts and materials: (i) about 50.1 g of dewatered hemp hurd, (ii) about 20 g of water, (iii) about 5 g of Prolite™ Microsphere Filler Blend 130 polymeric microspheres, (iv) about 14 g of epoxy powder, (v) about 25.8 g of acResin™ latex acrylic hot-melt polymer, and (vi) about 18.3 g of Stryonal™ ND (BASF Corp., USA). Thus, the binding agent included three different components, including two latexes.

The balsa-like intermediate product thus comprised:

| | Percent Amount |
|---|---|
| Component | By Weight |
| Plant Hurd Material | 38% |
| Water | 15% |
| Polymeric Microspheres | 4% |
| Epoxy Powder (pre-mixed into | 11% |
| latex polymers) | |
| Latex Polymer-acResin ™ | 19% |
| Latex Polymer-Stryonal ND | 14% |

The balsa-like intermediate product was pressed, heated and dried as described in Example 5. The balsa-like wood alternative product comprised:

| | Percent Amount |
|---|---|
| Component | By Weight |
| Plant Hurd Material | 44% |
| Polymeric Microspheres | 4% |
| Epoxy Powder | 12% |
| Latex Polymer-acResin ™ | 23% |
| Latex Polymer-Stryonal ND | 16% |

This product was trimmed to a desired sheet size.

As in Example 5, the balsa-like wood alternative product of this example was found to be a reliable replacement to natural balsa wood, including having suitable flexural strength, high compression strength, retaining low-density/light-weight characteristics, and displaying suitable absorption characteristics in respect of fiberglass/styrene resins. It was found that the addition of Stryonal ND further improved the ability of the balsa-like wood alternative product to resist styrene resin absorption, while retaining overall physical strength.

### Example 8

In this example, the process of Example 5 was repeated using the following amounts and materials: (i) about 100.1 g of dewatered hemp hurd, (ii) about 40.4 g of water, (iii) about 10 g of Prolite™ Microsphere Filler Blend 130 polymeric microspheres, (iv) about 31.9 g of epoxy powder, and (v) about 64.1 g of acResin™ latex acrylic hot-melt polymer.

The balsa-like intermediate product thus comprised:

| | Percent Amount |
|---|---|
| Component | By Weight |
| Plant Hurd Material | 41% |
| Water | 16% |
| Polymeric Microspheres | 4% |
| Epoxy Powder (pre-mixed into latex polymer) | 13% |
| Latex Polymer | 23% |

The balsa-like intermediate product was pressed, heated and dried as described in Example 5. The balsa-like wood alternative product comprised:

| | Percent Amount |
|---|---|
| Component | By Weight |
| Plant Hurd Material | 49% |
| Polymeric Microspheres | 6% |
| Epoxy Powder | 15% |
| Latex Polymer | 31% |

This product was trimmed to a desired sheet size.

As in Example 5, the balsa-like wood alternative product of this example was found to be a reliable replacement to natural balsa wood, including having suitable flexural strength, high compression strength, retaining low-density/light-weight characteristics, and displaying suitable absorption characteristics in respect of fiberglass/styrene resins. It was found that by increasing the relative amounts of hurd, a higher density material was obtained.

### Example 9

Having regard to Example 8 and the formation of a higher density material, this example was performed without polymeric microspheres and without the epoxy powder. Thus, only the thermoplastic resin, acResin™, was used as a binding agent. Low density was not as desired of a feature since the target product was a lighter weight version of MDF (Medium Density Fiberboard) that is capable of forming into moldable shapes at a later time.

In this example, the following amounts and materials: (i) about 100.4 g of dewatered hemp hurd, (ii) about 40.7 g of water, and (iii) about 74.7 g of acResin™ latex acrylic hot-melt polymer.

The dewatered hemp hurd was placed into a high shear blender and agitated. The water was added as a fine mist to the dewatered hemp hurd to provide a hydrated hurd material. The binding agent was then mixed with the prepared hydrated hurd material under high shear mixing. The resulting material (a homogenous mixture) was pressed, without heating, into a loose cake. The loose cake was transferred to a heated press and pressed at a temperature of about 165° C., for about 9 minutes, to firm up the cake. To dry the cake, the cake removed from the press and placed into an oven set at about 135° C. for about 30 minutes. The dried cake was then returned to the heated press set at about 165° C. and pressed again for about 9 minutes, removed, and allowed to cool to ambient temperature to provide a lighter-weight MDF type material. This product was trimmed to a desired sheet size. Advantageously, it was also found that this product could be formed into moldable shapes at a later time, quite unlike regular MDF.

### Example 10

In this example, the process of Example 9 was repeated except the thermoplastic resin was replaced with a thermoset resin to create an MDF-like material.

In this example, the following amounts and materials: (i) about 100.1 g of dewatered hemp hurd, (ii) about 40.3 g of water, and (iii) about 86.1 g of Acrodur™ (BASF Corp., USA).

With these adjusted amounts as well as the addition of the thermoset resin, it was found that an MDF-like product could be produced.

In any of Examples 5-10 above, the latex polymer binding agent may be used wet or as-is weight.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1.-37. (canceled)

38. A method for preparing a balsa-like wood alternative product, the method comprising:
providing a plant hurd material comprising at least 75% hurd by weight;
combining the plant hurd material with an aqueous medium to provide a hydrated hurd mixture;
combining, in any order, the hydrated hurd mixture with low-density spheres and one or more binding agents to provide a balsa-like intermediate product; and
drying the balsa-like intermediate product to provide the balsa-like wood alternative product.

39. The method of claim 38, wherein the plant hurd material comprises at least 95% hurd by weight.

40. The method of claim 38, wherein the plant hurd material comprises at least 99% hurd by weight.

41. The method of claim 38, wherein the step of providing the plant hurd material comprises decorticating a plant material to separate a hurd component from the plant material.

42. The method of claim 38, wherein hurd fibers of the plant hurd material have an average particle size of about 0.125 inches by about 0.25 inches.

43. The method of claim 38, wherein the step of combining the plant hurd material with the aqueous medium comprises mixing the aqueous medium into the plant hurd material to hydrate cellulose within the plant hurd material.

44. The method of claim 38, wherein the aqueous medium is water.

45. The method of claim 38, wherein the step of combining the hydrated hurd mixture with the low-density spheres and the one or more binding agents comprises:
mixing the hydrated hurd mixture with the low-density spheres to provide a low-density hurd mixture; and
mixing the low-density hurd mixture with the one or more binding agents to provide the balsa-like intermediate product.

46. The method of claim 38, wherein the step of drying the balsa-like intermediate product comprises heating.

47. The method of claim 38, wherein the combining steps comprise a high shear mixing.

48. The method of claim 38, wherein the combining steps are performed until substantially homogenous mixtures are provided.

49. The method of claim 38, wherein the step of combining the plant hurd material with the aqueous medium comprises:
agitating the plant hurd material; and
spraying the aqueous medium as a fine mist onto the plant hurd material during the agitation.

50. The method of claim 38, wherein the aqueous medium is combined with the plant hurd material at an amount of between about 30% and about 50% by weight of the plant hurd material.

51. The method of claim 38, wherein the plant hurd material is from hemp, jute, kenaf, ramie, flax, or any combination thereof.

52. The method of claim 38, wherein the plant hurd material is from hemp.

53. The method of claim 38, wherein the binding agent comprises an acrylic resin, an acrylic emulsion, a polymer dispersion, a styrene resin, a styrene-butadiene dispersion, an epoxy resin, an epoxy powder, a polyester, a phenolic resin, a latex polymer, or any combination thereof.

54. The method of claim 38, wherein the binding agent comprises at least one dry epoxy powder and at least one latex polymer.

55. The method of claim 54, wherein the at least one latex polymer is a reactive thermoset latex, a thermoplastic latex, or a combination thereof.

56. The method of claim 55, wherein the at least one latex polymer is a water-based latex thermoplastic acrylic.

57. The method of claim 54, wherein the latex polymer comprises one or more functional groups selected from the group consisting of an alcohol, a carboxylic acid, or an amine.

58. The method of claim 38, wherein the low-density spheres comprise polymeric microspheres, glass microspheres, ceramic microspheres, or any combination thereof.

59. The method of claim 58, wherein the low-density spheres are polymeric microspheres.

60. The method of claim 38, wherein the aqueous medium is combined at an amount of about 40% by weight of cellulose weight in the plant hurd material.

61. The method of claim 38, wherein the low-density spheres are combined at an amount of about 20% by weight of cellulose weight in the plant hurd material.

62. The method of claim 38, wherein, after drying, the balsa-like wood alternative product comprises:
between about 20% and about 75% by weight of the plant hurd material;
between about 1% and about 25% by weight of the low-density spheres; and
between about 10% and about 75% by weight binding agent.

63. The method of claim 38, wherein, after drying, the balsa-like wood alternative product comprises:
between about 40% and about 60% by weight plant hurd material;
between about 2% and about 15% by weight low-density spheres; and
between about 40% and about 60% by weight binding agent.

64. The method of claim 38, wherein the step of drying the balsa-like intermediate product comprises:
pressing the balsa-like intermediate product into a balsa-like cake;
heating the balsa-like cake to one or more temperatures between about 120° C. and about 180° to dry the balsa-like cake;
curing the dried balsa-like cake at a temperature between about 160° C. and 180° C.; and
cooling the cured balsa-like cake to between about 15° C. and about 30° C. to provide the balsa-like wood alternative product.

65. The method of claim 64, wherein the heating and curing steps are at a temperature of at most 165° C.

66. The method of claim 38, wherein the plant hurd material is a high-absorbency hurd material as described herein.

67.-71. (canceled)
